(19) United States
(12) Patent Application Publication
(10) Pub. No.: US 2025/0115288 A1
(43) Pub. Date: Apr. 10, 2025

(54) REAR-WHEEL STEERING APPARATUS FOR VEHICLE

(71) Applicant: HYUNDAI MOBIS CO., LTD., Seoul (KR)

(72) Inventor: Tae Yoon KIM, Yongin-si (KR)

(73) Assignee: HYUNDAI MOBIS CO., LTD., Seoul (KR)

(21) Appl. No.: 18/806,100

(22) Filed: Aug. 15, 2024

(30) Foreign Application Priority Data
Oct. 6, 2023 (KR) 10-2023-0133323

(51) Int. Cl. B62D 5/04; B62D 7/15

(52) U.S. Cl. CPC B62D 5/0445; B62D 5/0424; B62D 7/1581

(57) ABSTRACT

A rear-wheel steering apparatus for a vehicle includes: a housing; a driver supported by the housing and configured to generate a driving force; a transmission shaft movably accommodated in the housing and configured to reciprocate by receiving the driving force from the driver; an anti-rotation member fixed to the housing and configured to restrain a rotation of the transmission shaft; and a guide member coupled to the anti-rotation member to be interposed between the transmission shaft and the anti-rotation member and configured to guide a movement of the transmission shaft.

### CROSS-REFERENCE TO RELATED APPLICATION

The present application claims priority to and the benefit of Korean Patent Application No. 10-2023-0133323, filed on Oct. 10, 2023 in the Korean Intellectual Property Office, the entire disclosure of which is incorporated herein by reference.

### BACKGROUND

### Field

Exemplary embodiments of the present disclosure relate to a rear-wheel steering apparatus for a vehicle, and more particularly, to a rear-wheel steering apparatus for a vehicle, which may reduce manufacturing cost by simplifying configuration.

### Description of the Related Art

A rear-wheel steering (RWS) apparatus is a type of an all-wheel steering (AWS) apparatus that may enhance the responsiveness and driving safety of a vehicle and reduce the turning radius of the vehicle.

The rear-wheel steering apparatus for a vehicle typically has a structure in which a lead screw is coupled to a screw nut. A screw is formed on the lead screw, and the lead screw and the screw nut are spirally coupled. When the screw nut is rotated by a driver, the lead screw moves axially. This operation steers rear-wheels of the vehicle.

Meanwhile, axial rotation of the lead screw is prevented by an anti-roll bush meshingly engaged to a spline formed on the lead screw, and a radial clearance of the lead screw is prevented by liner bushes installed on both sides of the lead screw.

The related art of the present invention is disclosed in Korean Patent Application Publication No. 10-2018-0120447 (published on Nov. 6, 2018 and entitled “REAR WHEEL STEERING APPARATUS”.)

### SUMMARY

An object of the present disclosure is to provide a rear-wheel steering apparatus for a vehicle, which may prevent axial rotation of a transmission shaft receiving a rotational force from a driver and reciprocating in a housing, and may stably guide a linear movement of the transmission shaft.

According to an aspect of the present disclosure, there is provided a rear-wheel steering apparatus for a vehicle, which may include: a housing; a driver supported by the housing and configured to generate a driving force; a transmission shaft movably accommodated in the housing and configured to reciprocate by receiving the driving force from the driver; an anti-rotation member fixed to the housing and configured to restrain a rotation of the transmission shaft; and a guide member coupled to the anti-rotation member to be interposed between the transmission shaft and the anti-rotation member and configured to guide a movement of the transmission shaft.

The transmission shaft may include: a first shaft having a screw, which converts a rotational force generated by the driver into a linear motion; and a second shaft coupled to the first shaft to extend from the first shaft and configured to be in contact with the guide member.

The guide member may be formed in a hollow shape so as to surround an outer peripheral surface of the second shaft. The anti-rotation member may be formed in a hollow shape so as to surround an outer peripheral surface of the guide member.

The slit-hole formed in a lengthwise direction of the guide member may be provided on a first surface of the guide member.

A first anti-rotation surface configured to restrain a rotation of the second shaft may be formed on a second surface of the guide member. A second anti-rotation surface configured to restrain a rotation of the guide member may be formed on the anti-rotation member in contact with the second surface of the guide member.

The anti-rotation member may have an anti-free movement portion, which is formed to be recessed on an inner surface of the anti-rotation member to restrain a free movement of the guide member.

An inclination surface may be formed, on one or both sides of the anti-free movement portion, to be spaced apart from an end of the guide member.

A flange seated on an end of the anti-rotation member may be provided on an end of the guide member.

The flange may be latched to the anti-rotation member when the transmission shaft moves axially.

The anti-rotation member may have a recess, which is formed to be recessed on the inner surface of the anti-rotation member and formed in a lengthwise direction of the anti-rotation member.

A first anti-rotation surface, which is configured to restrain a rotation of the second shaft, may be formed on the first surface of the guide member. A second anti-rotation surface, which is configured to restrain a rotation of the guide member, may be formed on the anti-rotation member in contact with the first surface of the guide member. A plurality of the recesses may be arranged on the anti-rotation member, along an inner peripheral surface of the anti-rotation member, to be spaced apart from each other.

According to the present disclosure, the rear-wheel steering apparatus for a vehicle may prevent the transmission shaft, which reciprocates in the housing by the anti-rotation member fixed to the housing and configured to surround the transmission shaft, from rotating axially inside the housing.

In addition, according to the present disclosure, the rear-wheel steering apparatus for a vehicle may stably guide a linear movement of the transmission shaft, which is slidingly moved by the guide member coupled to the inner side of the anti-rotation member to be interposed between the transmission shaft and the anti-rotation member.

In addition, according to the present disclosure, the rear-wheel steering apparatus for a vehicle may improve productivity by simplifying the structure and reducing cumulative tolerances between elements, and may reduce manufacturing dispersion by increasing the degree of freedom for coaxiality compared to conventional apparatus.

### BRIEF DESCRIPTION OF THE DRAWINGS

FIG. 1 is a cross-sectional view of one side illustrating a rear-wheel steering apparatus for a vehicle according to embodiments of the present disclosure.

FIG. 2 is a cross-sectional view taken along line A-A in FIG. 1.

FIG. 3 is a perspective view illustrating one embodiment of a guide member in the rear-wheel steering apparatus for a vehicle according to a first embodiment of the present disclosure.

FIG. 4 is a perspective view illustrating another embodiment of the guide member in the rear-wheel steering apparatus for a vehicle according to the first embodiment of the present disclosure.

FIG. 5 is a cross-sectional view of one side illustrating the guide member coupled to an anti-rotation member in the rear-wheel steering apparatus for a vehicle according to the first embodiment of the present disclosure.

FIG. 6 is a perspective view illustrating one embodiment of the guide member in the rear-wheel steering apparatus for a vehicle according to a second embodiment of the present disclosure.

FIG. 7 is a perspective view illustrating another embodiment of the guide member in the rear-wheel steering apparatus for a vehicle according to the second embodiment of the present disclosure.

FIG. 8 is a perspective view illustrating yet another embodiment of the guide member in the rear-wheel steering apparatus for a vehicle according to the second embodiment of the present disclosure.

FIG. 9 is a cross-sectional view of one side illustrating the guide member coupled to the anti-rotation member in the rear-wheel steering apparatus for a vehicle according to the second embodiment of the present disclosure.

FIG. 10 is a front cross-sectional view illustrating the guide member coupled to the anti-rotation member in the rear-wheel steering apparatus for a vehicle according to a third embodiment of the present disclosure.

FIG. 11 is a front cross-sectional view illustrating the guide member coupled to the anti-rotation member in the rear-wheel steering apparatus for a vehicle according to a fourth embodiment of the present disclosure.

### DETAILED DESCRIPTION

Exemplary embodiments of a rear-wheel steering apparatus for a vehicle will be described below with reference to the accompanying drawings. It should be considered that the thickness of each line or the size of each component in the drawings may be exaggeratedly illustrated for clarity and convenience of description. In addition, the terms as used herein are defined in consideration of functions of the present disclosure, and these terms may change depending on a user or operator's intention or practice. Therefore, these terms should be defined based on the entirety of the disclosure set forth herein.

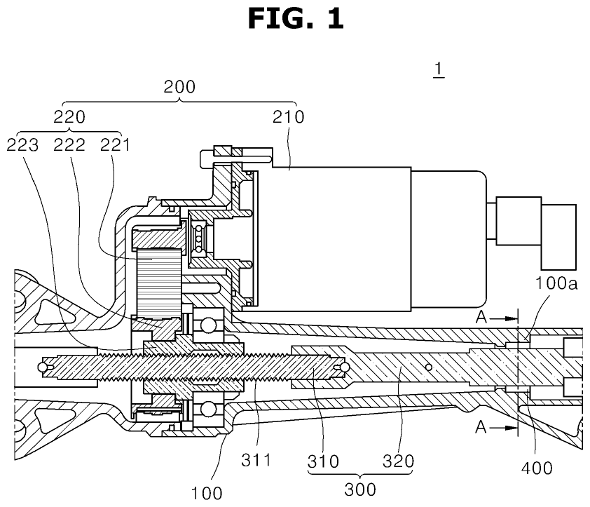

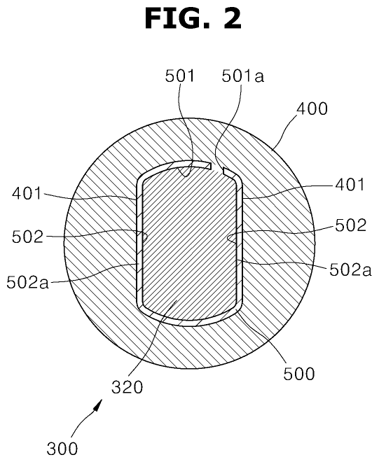

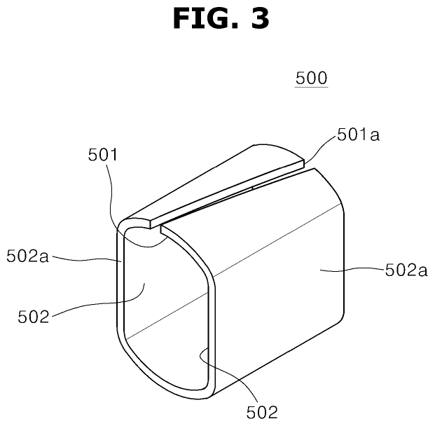

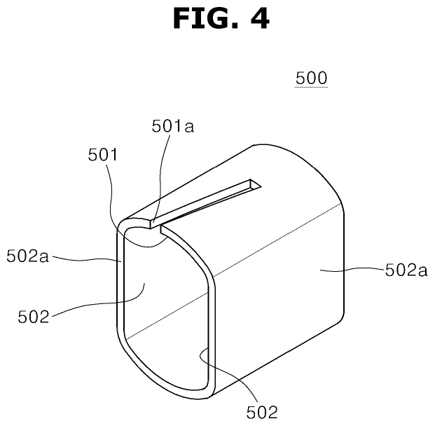

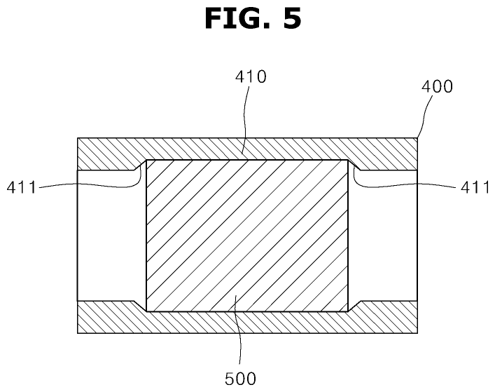

FIG. 1 is a cross-sectional view of one side illustrating a rear-wheel steering apparatus for a vehicle according to embodiments of the present disclosure. FIG. 2 is a cross-sectional view taken along line A-A in FIG. 1. FIG. 3 is a perspective view illustrating one embodiment of a guide member in the rear-wheel steering apparatus for a vehicle according to a first embodiment of the present disclosure. FIG. 4 is a perspective view illustrating another embodiment of the guide member in the rear-wheel steering apparatus for a vehicle according to the first embodiment of the present disclosure. FIG. 5 is a cross-sectional view of one side illustrating the guide member coupled to the anti-rotation member in the rear-wheel steering apparatus for a vehicle according to the first embodiment of the present disclosure.

Referring to FIGS. 1 to 5, the rear-wheel steering apparatus 1 for a vehicle according to the first embodiment of the present disclosure may include a housing 100, a driver 200, a transmission shaft 300, an anti-rotation member 400, and a guide member 500.

The housing 100 forms a schematic appearance of the rear-wheel steering apparatus 1 for a vehicle according to an embodiment of the present disclosure and supports as a whole the driver 200, the transmission shaft 300, the anti-rotation member 400, and the guide member 500, which will be described later.

The housing 100 may be formed to have a hollow cylindrical shape with an empty interior. The housing 100 may be arranged between two rear-wheels on both sides (not illustrated) of a vehicle. The housing 100 may be arranged in a lengthwise direction parallel to a width direction of a vehicle.

A specific shape of the housing 100 is not limited to the shape illustrated in FIG. 1, but may vary with a design change within the technical spirit of the shape that may support as a whole the configuration of the rear-wheel steering apparatus 1 for a vehicle according to an embodiment of the present disclosure.

The housing 100 may include a fixing groove 100a. The fixing groove 100a may be formed to be recessed on an inner surface of the housing 100, and may be formed in a circumferential direction of the housing 100. The anti-rotation member 400, which will be described later, may be seated on the inside of the fixing groove 100a and fixed to the housing 100.

The driver 200 is supported by the housing 100 and generates a driving force to move the transmission shaft 300, which will be described later, inside the housing 100. The driver 200 may include a power generation part 210 and a power transmission part 220.

The power generation part 210 receives power from an external source and generates a rotational force. The power generation part 210 is fixed to the housing 100 and supports as a whole the power transmission part 220, which will be described later.

The power generation part 210 may be described with an example of various types of electric motors, such as AC, DC, and BLDC motors, and the like, which convert power input from an external source into a rotational force. The power generation part 210 may be fixed to an outer surface of the housing 100 by bolting, welding, or the like.

The power transmission part 220 is connected to the power generation part 210 and the transmission shaft 300, which will be described later, and transmits the rotational force generated by the power generation part 210 to the transmission shaft 300. The power transmission part 220 may include a first power transmission member 221 rotating with an output shaft of the power generation part 210, a second power transmission member 222 connected to the first power transmission member 221, and a nut 223 connected to the second power transmission member 222.

The nut 223 receives the rotational force from the second power transmission member 222 to move the transmission shaft 300. The nut 223 may be formed to have a hollow ring shape arranged to surround an outer peripheral surface of the transmission shaft 300.

The nut 223 includes a thread on an inner peripheral surface thereof and is spirally coupled to a screw 311 provided on the transmission shaft 300. The nut 223 rotates, with the second power transmission member 222, about a central axis of the transmission shaft 300 when the power generation part 210 is driven.

A specific shape of the power transmission part 220 is not limited to the shape illustrated in FIG. 1, but may vary with a design change within the technical spirit of the shape that may enable the rotational force generated by the power generation part 210 to be transmitted to the transmission shaft 300.

The transmission shaft 300 may be accommodated inside the housing 100, and may move in a direction parallel to a lengthwise direction of the housing 100. Both ends of the transmission shaft 300 may be connected to a pair of tie rods (not illustrated), respectively, which are connected to the rear-wheels of a vehicle.

The transmission shaft 300 receives a driving force from the driver 200 to reciprocate inside the housing 100. As the transmission shaft 300 reciprocates inside the housing 100, a force is transmitted to the tie rods connected to both ends of the transmission shaft 300, respectively, thereby changing the angle of the rear-wheels. The transmission shaft 300 may include a first shaft 310 and a second shaft 320.

The first shaft 310 may be form an exterior appearance of one side of the transmission shaft 300. The first shaft 310 is connected to the driver 200 and converts the rotational force generated by the driver 200 into a linear motion. Thus, the first shaft 310 may cause the transmission shaft 300 to reciprocate linearly inside the housing 100.

The first shaft 310 may be formed to have a rod shape with the screw 311 provided on an outer peripheral surface thereof. The first shaft 310 may be arranged in a lengthwise direction parallel to the lengthwise direction of the housing 100.

The second shaft 320 may extend from the first shaft 310 to form an exterior appearance of the other side of the transmission shaft 300. The second shaft 320 may be formed to extend from one end (the right side in FIG. 1) of the first shaft 310 in a direction parallel to a lengthwise direction of the first shaft 310.

The second shaft 320 may be manufactured integrally with the first shaft 310, or alternatively, may be manufactured separately from the first shaft 310 and coupled to the first shaft 310. An outer peripheral surface of the second shaft 320 may be in contact with an inner peripheral surface of the guide member 500, which will be described later.

The anti-rotation member 400 is coupled to the inside of the housing 100. The anti-rotation member 400 is seated on the inside of the fixing groove 100a formed on an inner surface of the housing 100 to be fixed to the housing 100. To be more specific, the anti-rotation member 400 is coupled to the housing 100 with an inner peripheral surface of the housing 100 and an outer peripheral surface of the anti-rotation member 400 being in contact with each other.

The anti-rotation member 400 restrains rotation of the transmission shaft 300 to prevent relative rotation between the housing 100 and the transmission shaft 300.

The anti-rotation member 400 allows the transmission shaft 300 to reciprocate in the lengthwise direction of the housing 100, while preventing the transmission shaft 300 from rotating axially inside the housing 100.

The anti-rotation member 400 is located on a peripheral portion of the second shaft 320. The anti-rotation member 400 may be formed in an empty hollow shape with a center portion thereof being penetrated in an axial direction of the transmission shaft 300 so as to surround the entire outer peripheral surface of the guide member 500, which will be described later, interposed between the anti-rotation member 400 and the second shaft 320.

The guide member 500 is coupled to an inner side of the anti-rotation member 400. The guide member 500 is interposed between the second shaft 320 and the anti-rotation member 400. The guide member 500 may be formed in an empty hollow shape with a center portion thereof being penetrated in the axial direction of the transmission shaft 300 so as to surround the entire outer peripheral surface of the second shaft 320.

The guide member 500 may be arranged such that the outer peripheral surface of the guide member 500 is in contact with an inner peripheral surface of the anti-rotation member 400, and such that the inner peripheral surface of the guide member 500 is in contact with the outer peripheral surface of the second shaft 320.

The guide member 500 may support the transmission shaft 300 inside the anti-rotation member 400 to guide a sliding movement of the second shaft 320.

The guide member 500 may prevent the transmission shaft 300 from deviating from a correct position thereof and moving freely in a radial direction of the housing 100 inside the housing 100. Thus, the guide member 500 may prevent the transmission shaft 300 from being wedged or colliding with an inner wall of the housing 100 due to deflection or the like.

The inner peripheral surface of the guide member 500 may be made of a material having a low coefficient of friction in order to stably support the transmission shaft 300, while not excessively interfering with a movement of the second shaft 320.

The guide member 500 may include a slit-hole 501a. The slit-hole 501a may be provided on a first surface 501 of the guide member 500. The slit-hole 501a may be formed by penetrating the first surface 501 in an inward and outward direction thereof.

The slit-hole 501a may be formed in a long-hole shape elongated in a lengthwise direction of the guide member 500, which is in the same direction as the axial direction of the transmission shaft 300. The slit-hole 501a may be formed in a straight-line shape or in an oblique-line shape toward a lengthwise direction of the guide member 500.

When the guide member 500 is coupled to the anti-rotation member 400, the slit-hole 501a may be loosened or wedged due to a tolerance between the anti-rotation member 400 and the guide member 500, thereby minimizing dispersion of a frictional force during the sliding movement of the second shaft 320 so as to achieve uniform performance. In addition, the slit-hole 501a may allow air to flow in the lengthwise direction of the guide member 500.

The slit-hole 501a may be formed by penetrating between both ends of the guide member 500, or may be formed at one end of the guide member 500 for approximately ⅔ of the length of the guide member 500.

The guide member 500 may include a first anti-rotation surface 502a. The first anti-rotation surface 502a may be formed on a second surface 502 of the guide member 500. Here, the second surfaces 502 may be located on both sides of the first surface 501, respectively. To be more specific, a pair of the second surfaces 502 may be arranged to be spaced apart from each other and to oppose each other.

The first anti-rotation surface 502a may be formed in a flat shape. The first anti-rotation surface 502a may restrain axial rotation of the second shaft 320.

The anti-rotation member 400 in contact with the second surface 502 of the guide member 500 may include a second anti-rotation surface 401. The second anti-rotation surface 401 may be formed on an inner surface of the anti-rotation member 400 in contact with the second surface 502.

The second anti-rotation surface 401 may be formed in a flat shape. The second anti-rotation surface 401 may restrain rotation of the guide member 500 to prevent the guide member 500 from rotating with the second shaft 320.

The anti-rotation member 400 may have an anti-free movement portion 410. The anti-free movement portion 410 may be formed to be recessed on the inner surface of the anti-rotation member 400. The anti-free movement portion 410 may be formed on an inner peripheral surface of the anti-rotation member 400. The guide member 500 may be seated on the inside of the anti-free movement portion 410, and the outer peripheral surface of the guide member 500 may be press-fit to the inner surface of the anti-rotation member 400 so that the guide member 500 may be fixed.

Thus, the anti-free movement portion 410 may restrain the guide member 500 to prevent the guide member 500 from moving freely in the axial direction of the transmission shaft 300 when the transmission shaft 300 moves.

An inclination surface 411 may be formed, on one or both sides of the anti-free movement portion 410, to be inclined at a predetermined angle to be spaced apart from an end of the guide member 500. The inclination surface 411 may be chamfered so that the inclination surface 411 does not come into contact with the end of the guide member 500. The inclination surface 411 may minimize impact sound generated by collision with the anti-rotation member 400 caused by the free movement of the guide member 500.

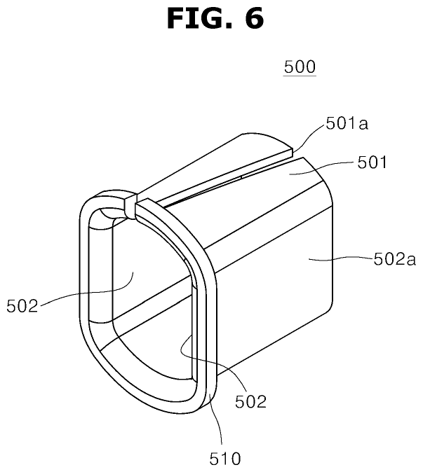

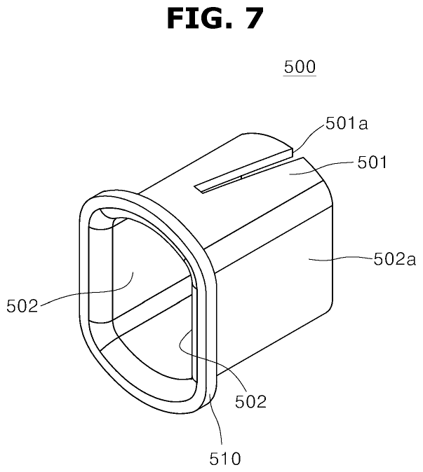

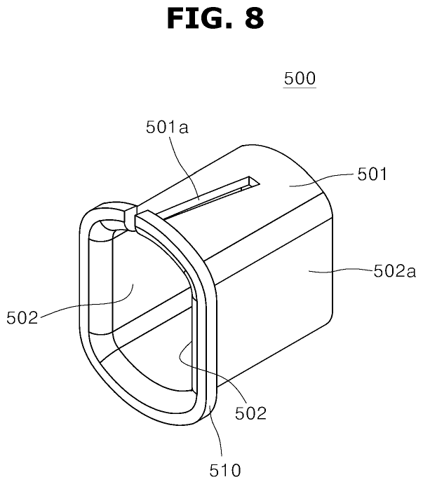

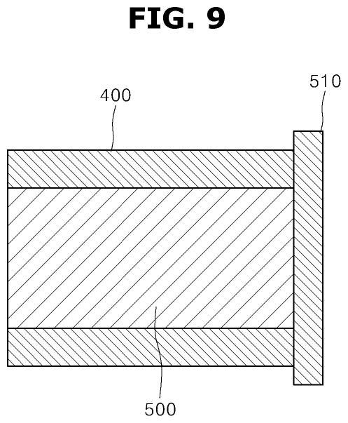

FIG. 6 is a perspective view illustrating one embodiment of the guide member in the rear-wheel steering apparatus for a vehicle according to a second embodiment of the present disclosure. FIG. 7 is a perspective view illustrating another embodiment of the guide member in the rear-wheel steering apparatus for a vehicle according to the second embodiment of the present disclosure. FIG. 8 is a perspective view illustrating yet another embodiment of the guide member in the rear-wheel steering apparatus for a vehicle according to the second embodiment of the present disclosure. FIG. 9 is a cross-sectional view of one side illustrating the guide member coupled to the anti-rotation member in the rear-wheel steering apparatus for a vehicle according to the second embodiment of the present disclosure.

The rear-wheel steering apparatus 1 for a vehicle according to the second embodiment of the present disclosure may include the housing 100, the driver 200, the transmission shaft 300, the anti-rotation member 400, and the guide member 500.

In describing the rear-wheel steering apparatus 1 for a vehicle according to the second embodiment of the present disclosure, another embodiment of the guide member 500 described in the rear-wheel steering apparatus 1 for a vehicle according to the first embodiment of the present disclosure will be described below.

For the configuration of the elements aside from the guide member of the rear-wheel steering apparatus 1 for a vehicle according to the second embodiment of the disclosure, the same description of the rear-wheel steering apparatus 1 for a vehicle according to the first embodiment of the disclosure may be applied.

Referring to FIGS. 6 to 9, the guide member 500 may further include a flange 510. The flange 510 may be integrally provided on one end of the guide member 500 in the lengthwise direction thereof. The flange 510 may be formed to protrude from the outer peripheral surface of the guide member 500, and may be formed along the outer peripheral surface of the guide member 500.

The flange 510 may be formed to have the same diameter as the anti-rotation member 400 or to have a larger diameter than the anti-rotation member 400. Thus, when the guide member 500 is coupled to the inner side of the anti-rotation member 400, the flange 510 may be seated on one end of the anti-rotation member 400 in the lengthwise direction thereof.

When the transmission shaft 300 moves axially, the flange 510 may be latched to the anti-rotation member 400 so that the guide member 500 may be fixed to the anti-rotation member 400

The guide member 500 may include the slit-hole 501a. The slit-hole 501a may be provided on the first surface 501 of the guide member 500. The slit-hole 501a may be formed by penetrating the first surface 501 in the inward and outward direction thereof.

The slit-hole 501a may be formed in a long-hole shape elongated in the lengthwise direction of the guide member 500, which is in the same direction as the axial direction of the transmission shaft 300. The slit-hole 501a may be formed in a straight-line shape or in an oblique-line shape toward the lengthwise direction of the guide member 500.

The slit-hole 501a may be formed by penetrating between both ends of the guide member 500, or may be formed at one end or the other end of the guide member 500 for approximately ⅔ of the length of the guide member 500.

FIG. 10 is a front cross-sectional view illustrating the guide member coupled to the anti-rotation member in the rear-wheel steering apparatus for a vehicle according to a third embodiment of the present disclosure.

Referring to FIG. 10, the rear-wheel steering apparatus 1 for a vehicle, according to the third embodiment of the present disclosure may include the housing 100, the driver 200, the transmission shaft 300, the anti-rotation member 400, and the guide member 500.

In describing the rear-wheel steering apparatus 1 for a vehicle according to the third embodiment of the present disclosure, another embodiment of the anti-rotation member 400 and the guide member 500 described in the rear-wheel steering apparatus 1 for a vehicle according to the first embodiment or the second embodiment of the present disclosure will be described below.

For the configuration of the elements aside from the anti-rotation member and the guide member of the rear-wheel steering apparatus 1 for a vehicle according to the third embodiment of the disclosure, the same description of the rear-wheel steering apparatus 1 for a vehicle according to the first embodiment or the second embodiment of the disclosure may be applied.

The anti-rotation member 400 may include a recess 420. The recess 420 may be formed to be recessed on the inner surface of the anti-rotation member 400. The recess 420 may be formed to be elongated in the lengthwise direction of the anti-rotation member 400, which is in the same direction as the axial direction of the transmission shaft 300.

The recess 420 may be formed by penetrating between both ends of the anti-rotation member 400, or may be formed at one end or the other end of the anti-rotation member 400 for approximately ⅔ of the length of the anti-rotation member 400.

The recess 420 may be formed in a straight-line shape or in an oblique-line shape toward the lengthwise direction of the anti-rotation member 400. The recess 420 may allow air to flow in the lengthwise direction of the guide member 500.

The guide member 500 may include a first anti-rotation surface 503a. The first anti-rotation surface 503a may be formed on a first surface 503 of the guide member 500. The first anti-rotation surface 503a may be formed in a flat shape. The first anti-rotation surface 503a may restrain axial rotation of the second shaft 320.

The anti-rotation member 400 in contact with the first surface 503 of the guide member 500, may include a second anti-rotation surface 402. The second anti-rotation surface 402 may be formed on the inner surface of the anti-rotation member 400 in contact with the first surface 503.

The second anti-rotation surface 402 may be formed in a flat shape. The second anti-rotation surface 402 may restrain rotation of the guide member 500 to prevent the guide member 500 from rotating with the second shaft 320.

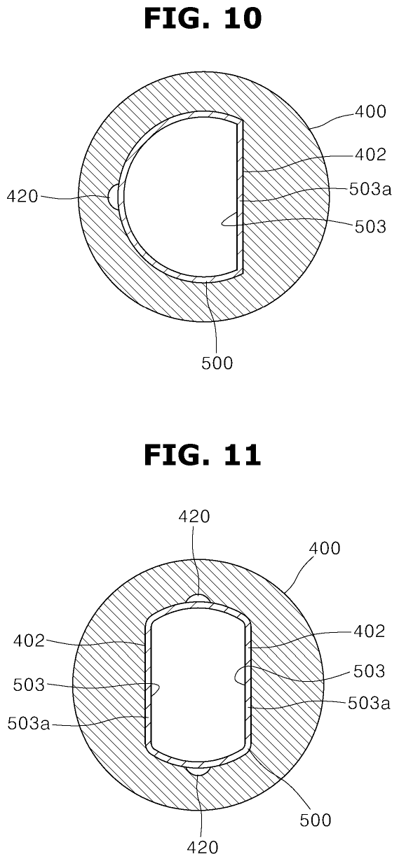

FIG. 11 is a front cross-sectional view illustrating the guide member coupled to the anti-rotation member in the rear-wheel steering apparatus for a vehicle according to a fourth embodiment of the present disclosure.

Referring to FIG. 11, the rear-wheel steering apparatus 1 for a vehicle, according to the fourth embodiment of the present disclosure may include the housing 100, the driver 200, the transmission shaft 300, the anti-rotation member 400, and the guide member 500.

In describing the rear-wheel steering apparatus 1 for a vehicle according to the fourth embodiment of the present disclosure, another embodiment of the guide member 500 described in the rear-wheel steering apparatus 1 for a vehicle according to the first embodiment, the second embodiment, or the third embodiment of the present disclosure will be described below.

For the configuration of the elements aside from the anti-rotation member of the rear-wheel steering apparatus 1 for a vehicle according to the fourth embodiment of the disclosure, the same description of the rear-wheel steering apparatus 1 for a vehicle according to the first embodiment, the second embodiment, or the third embodiment of the disclosure may be applied.

A plurality of the recesses 420 may be arranged, along the inner peripheral surface of the anti-rotation member 400, to be spaced apart from each other.

The first anti-rotation surface 503a provided on the guide member 500 may be formed on the first surface 503 of the guide member 500. A pair of the first surfaces 503 may be arranged to be spaced apart from each other and to oppose each other.

The second anti-rotation surface 402, which is provided on the anti-rotation member 400 and is in contact with the first surface 503 of the guide member 500, may be formed on the inner surface of the anti-rotation member 400.

The rear-wheel steering apparatus 1 for a vehicle according to the embodiments of the present disclosure may prevent the transmission shaft 300, which reciprocates in the housing 100 by the anti-rotation member 400 fixed to the housing 100 and configured to surround the transmission shaft 300, from rotating axially inside the housing 100.

The rear-wheel steering apparatus 1 for a vehicle according to the embodiments of the present disclosure may stably guide a linear movement of the transmission shaft 300, which is slidingly moved by the guide member 500 coupled to the inner side of the anti-rotation member 400 and interposed between the transmission shaft 300 and the anti-rotation member 400.

The rear-wheel steering apparatus 1 for a vehicle according to the embodiments of the present disclosure may improve productivity by simplifying the structure and reducing cumulative tolerances between elements, and may reduce manufacturing dispersion by increasing the degree of freedom for coaxiality compared to conventional apparatus.

The present disclosure has been described with reference to the embodiments illustrated in the drawings, but these are only exemplary. Those skilled in the art to which the technology pertains should understand that various modifications and other equivalent embodiments may be made without departing from the spirit and scope of the disclosure as defined in the following claims. Therefore, the true technical protection scope of the present disclosure will be determined by the following claims.

What is claimed is:

1. A rear-wheel steering apparatus for a vehicle, the apparatus comprising:
a housing;
a driver supported by the housing and configured to generate a driving force;
a transmission shaft movably accommodated in the housing and configured to reciprocate by receiving the driving force from the driver;
an anti-rotation member fixed to the housing and configured to restrain a rotation of the transmission shaft; and
a guide member coupled to the anti-rotation member to be interposed between the transmission shaft and the anti-rotation member and configured to guide a movement of the transmission shaft.

2. The apparatus of claim 1, wherein the transmission shaft comprises:
a first shaft comprising a screw converting a rotational force generated by the driver into a linear motion; and
a second shaft coupled to the first shaft and configured to be in contact with the guide member.

3. The apparatus of claim 2, wherein the guide member is formed in a hollow shape so as to surround an outer peripheral surface of the second shaft, and wherein the anti-rotation member is formed in a hollow shape so as to surround an outer peripheral surface of the guide member.

4. The apparatus of claim 3, wherein a slit-hole formed in a lengthwise direction of the guide member is provided on a first surface of the guide member.

5. The apparatus of claim 4, wherein a first anti-rotation surface configured to restrain a rotation of the second shaft is formed on a second surface of the guide member, and wherein a second anti-rotation surface configured to restrain a rotation of the guide member is formed on the anti-rotation member in contact with the second surface of the guide member.

6. The apparatus of claim 5, wherein the anti-rotation member comprises an anti-free movement portion formed to be recessed on an inner surface of the anti-rotation member to restrain a free movement of the guide member.

7. The apparatus of claim 6, wherein an inclination surface is formed, on one or both sides of the anti-free movement portion, to be spaced apart from an end of the guide member.

8. The apparatus of claim 5, wherein a flange seated on an end of the anti-rotation member is provided on one end of the guide member.

9. The apparatus of claim 8, wherein the flange is latched to the anti-rotation member when the transmission shaft moves axially.

10. The apparatus of claim 3, wherein the anti-rotation member comprises a recess formed to be recessed on an inner surface of the anti-rotation member and formed in a lengthwise direction of the anti-rotation member.

11. The apparatus of claim 10, wherein a first anti-rotation surface configured to restrain a rotation of the second shaft is formed on a first surface of the guide member, and wherein a second anti-rotation surface configured to restrain a rotation of the guide member is formed on the anti-rotation member in contact with the first surface of the guide member.

12. The apparatus of claim 10, wherein the recess includes a plurality of recesses that is arranged on the anti-rotation member, along an inner peripheral surface of the anti-rotation member, to be spaced apart from each other.
